(19) United States
(12) Patent Application Publication
(10) Pub. No.: US 2017/0284565 A1
(43) Pub. Date: Oct. 5, 2017

(54) HOLDER FOR TUBE CONNECTOR AND HOLDING STRUCTURE

(71) Applicant: DENSO International America, Inc., Southfield, MI (US)

(72) Inventor: Sean Paul Wade SCHONEBOOM, Bronson, MI (US)

(21) Appl. No.: 15/086,325

(22) Filed: Mar. 31, 2016

(51) Int. Cl. F16L 3/02; F16M 11/06; F16B 2/10; F16M 13/02; F16B 2/06

(52) U.S. Cl. CPC F16L 3/02; F16M 13/02; F16B 2/065; F16B 2/10; F16M 11/06

(57) ABSTRACT

The present disclosure provides a holder for holding a tube connector for an in-vehicle component. The holder includes a first arm that has a first engaging portion, a second arm that has a second engaging portion, and a fastener. A proximal portion of the first arm is connected to a proximal portion of the second arm at a connection point. The first arm and the second arm are configured to be flexible toward each other by flexing about the connection point. The first engaging portion and the second engaging portion engage with the tube connector by clamping the tube connector therebetween. The fastener fixes the proximal portion of the first arm and the proximal portion of the second arm to a base while biasing the first arm and the second arm toward each other.

### TECHNICAL FIELD

The present disclosure relates to a holder for holding a tube connector and a holding structure for an in-vehicle component.

### BACKGROUND

Typically, a vehicle has an engine room for housing an internal combustion engine on a front-end part of the vehicle, and a heat exchanger such as a radiator is installed in the engine room. Such a radiator includes a core and two tanks, and refrigerant such as cooling water circulates between the radiator and an internal combustion engine while exchanging heat between the refrigerant and air taken in the engine room.

Such a tank generally includes an inlet and an outlet, and the inlet and the outlet are in fluid communication with a water jacket of an internal combustion engine through tubes, hoses, pipes, or the like. However, due to recent downsizing trends in vehicles, the housing capacity of the engine room tends to be restricted, and therefore there may be difficulty in connecting such tubes to the radiator in such a limited engine room space.

### SUMMARY

According to an aspect of the present disclosure, a holder for holding a tube connector for an in-vehicle component includes a first arm, a second arm, a fastener. The first arm has a first engaging portion. The second arm has a second engaging portion. The proximal portion of the first arm is connected to a proximal portion of the second arm at a connection point. The first arm and the second arm are configured to be flexible toward each other by flexing about the connection point. The first engaging portion and the second engaging portion engage with the tube connector by clamping the tube connector therebetween. The fastener fixes the proximal portion of the first arm and the proximal portion of the second arm to a base while biasing the first arm and the second arm toward each other.

According to another aspect of the present disclosure, a holding structure for an in-vehicle component includes a holder, a tube connector, and a fastener. The holder includes a first arm having a first engaging portion and a second arm having a second engaging portion. The tube connector is detachably connected to an external connector. A proximal portion of the first arm is connected to a proximal portion of the second arm at a connection point. The first arm and the second arm are configured to be flexible by flexing about the connection point. The first engaging portion and the second engaging portion engage with the tube connector by clamping the tube connector therebetween. The fastener fixes the proximal portion of the first arm and the proximal portion of the second arm to a base while biasing the first arm and the second arm toward each other.

### BRIEF DESCRIPTION OF THE DRAWINGS

The disclosure, together with additional objectives, features and advantages thereof, will be best understood from the following description, the appended claims and the accompanying drawings, in which:

FIG. 1 is a perspective view showing a radiator to which a holding structure according to a first embodiment is applied;

FIG. 2 is a plan view of a holder fixed to a tank of the radiator;

FIG. 3 is a cross-sectional plan view of a tube connector held by the holder;

FIG. 4 is a schematic side view of the tube connector and the holder that are separated from each other;

FIG. 5 is a cross-sectional plan view of a tube connector held by a holder as a first modification;

FIG. 6 is a cross-sectional plan view of a tube connector as a second modification held by a holder;

FIG. 7 is a cross-sectional plan view of a tube connector as a third modification held by a holder;

FIG. 8A is an enlarged perspective view of a connection point of a holder according to a second embodiment;

FIG. 8 B is a plan view of the holder according to the second embodiment; and

FIG. 9 is an enlarged perspective view of a first engaging portion of the holder according to the second embodiment.

### DETAILED DESCRIPTION

Embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

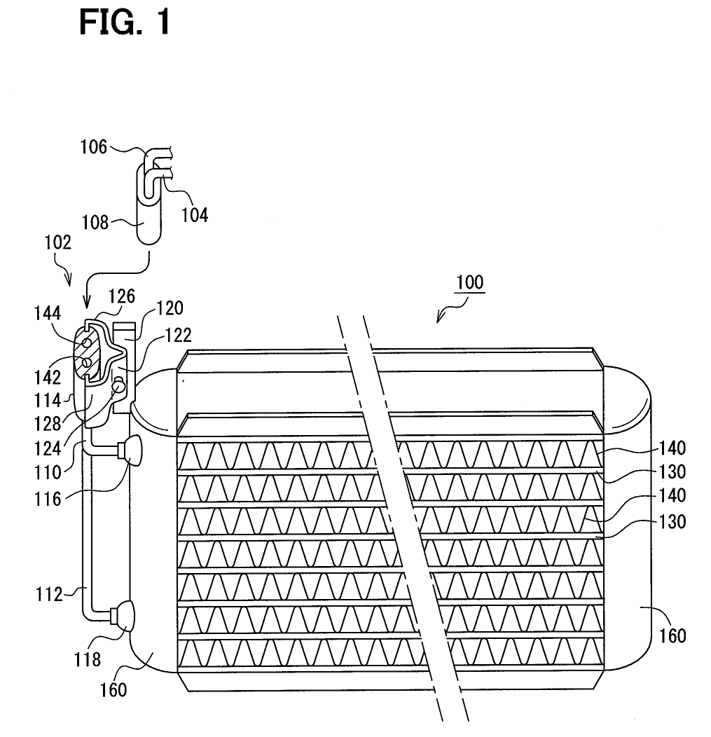

As follows, a first embodiment of the present disclosure will be described with reference to FIGS. 1 to 4. In the present embodiment, a radiator 100, as an in-vehicle component, is installed inside an engine room (not shown) defined by a frame of a vehicle. The radiator 100 is in fluid communication with an internal combustion engine (not shown) of the vehicle through a circulation circuit 102, and refrigerant such as cooling water circulates between the radiator 100 and the internal combustion engine through the circulation circuit 102.

The circulation circuit 102 includes a first tube 104 and a second tube 106 that are fluidly connected to the internal combustion engine, and distal ends of both the first tube 104 and the second tube 106 are bound by an external connector 108. The circulation circuit 102 further includes an inflow tube 110, an outflow tube 112, and a tube connector 114 that binds the inflow tube 110 and the outflow tube 112, as will be described below. The radiator 100 includes a pair of tanks 160, a plurality of tubes 130, and a plurality of fins 140. The fins 140 and the tubes 130 may be alternately arranged to form a core 100a of the radiator 100. The core 100a has a rectangular shape elongated in a lateral direction. The two tanks 160 are disposed at both sides of the core 100a to be opposite to each other in the lateral direction. In other words, the core 100a is interposed between the two tanks 160.

One of the two tanks 160 (the left side in FIG. 1 in this embodiment) has an inlet 116 and an outlet 118 for refrigerant. The inlet 116 is formed at one side of the tank 160 (an upper side of the tank 160 in FIG. 1) and the outlet 118 is formed at the other side of tank 160 (a lower side of the tank 160 in FIG. 1). The tank 160 also includes a bracket (base) 120 at the one side of the tank 160. The bracket 120 has a plate shape and is integrally formed in the tank 160 by, e.g., molding. The bracket 120 extends from the tank 160 in a direction along which the fins 140 and the tubes 130 of the core 100a are stacked. A threaded hole 120a is formed in the bracket 120. The bracket 120 serves as an attachment base for a holder 122, which will be described below.

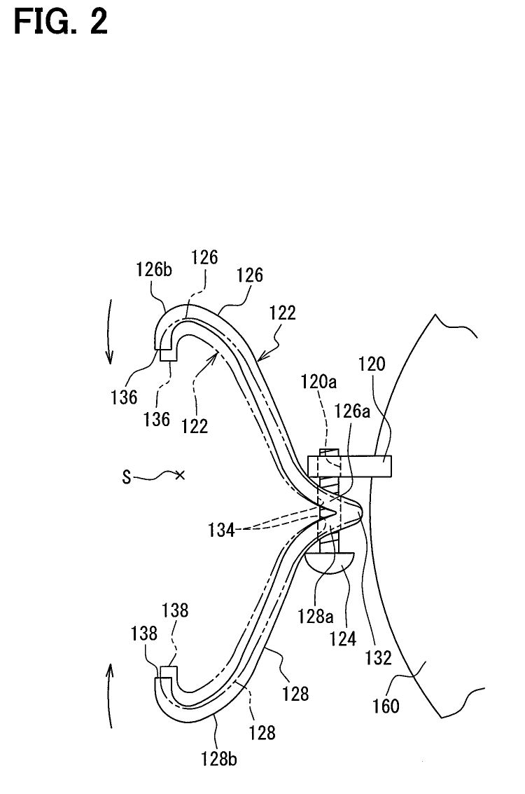

In the present embodiment, a holding structure for holding the tube connector 114 is employed. This holding structure holds the tube connector 114 by means of the holder 122 that is fixed to the bracket 120 through a screw 124 (fastener). The holder 122 is formed of resin by molding in a particular shape and is configured to be elastically flexible. As shown in FIG. 2, the holder 122 includes a first arm 126 and a second arm 128, and the first and second arms 126, 128 form a line-symmetric shape. The first arm 126 has a proximal portion 126a and the second arm 128 has a proximal portion 128a, and both the proximal portions 126a, 128a are connected to each other at a connection point 132. The first and second arms 126, 128 are configured to be flexible, or, more specifically, to flex toward each other about the connection point 132 when the first and second arms 126, 128 are biased by the screw 124.

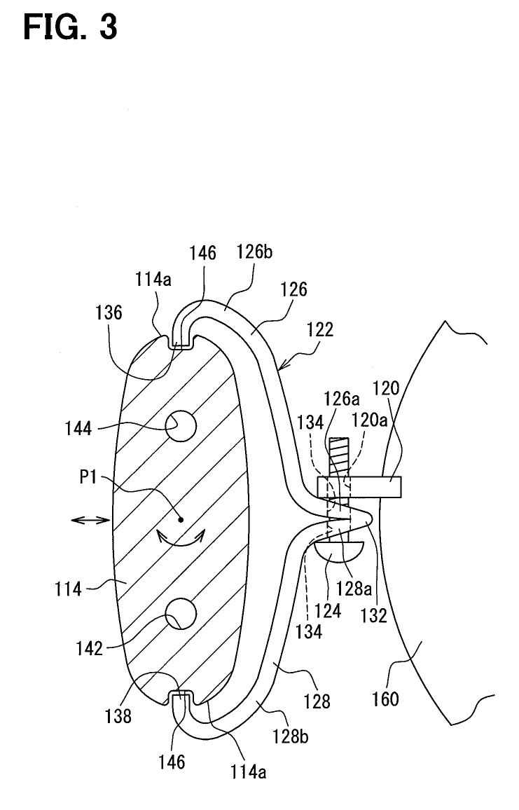

As shown in FIG. 3, each of the two proximal portions 126a, 128a extends to be gradually spaced away from each other so that the two proximal portions 126a, 128a of the first and second arms 126, 128 are substantially V-shaped. A hole 134 is formed in each of the proximal portion 126a of the first arm 126 and the proximal portion 128a of the second arm 128. The two holes 134 align with each other in an insertion direction of the screw 124.

The remaining portion of the first arm 126 other than the proximal portion 126a is a distal portion 126b that extends away from the second arm 128 and that is inwardly curved toward the second arm 128 at its distal end. Similarly, the remaining portion of the second arm 128 other than the proximal end is a distal portion 128b that extends away from the first arm 126 and that is inwardly curved toward the first arm 126 at its distal end. The distal portion 126b of the first arm 126 has a first engaging portion 136. The first engaging portion 136 protrudes from the distal portion 126b of the first arm 126 toward the second arm 128. The distal portion 128b of the second arm 128 has a second engaging portion 138 and the second engaging portion 138 protrudes from the distal portion 128b of the second arm 128 toward the first arm 126. A holding space S for the tube connector 114 is defined between the first and second engaging portions 136, 138 (see FIG. 2).

The tube connector 114, a so-called A/C jumper (air-conditioning jumper), is configured to be detachably connected to the external connector 108. The tube connector 114 causes the radiator 100 to be in fluid communication with the internal combustion engine when the tube connector 114 is connected to the external connector 108. Thus, the tube connector 114 serves as a part of the circulation circuit 102 for refrigerant. As shown in FIG. 3, the tube connector 114 has an oval-shaped cross-section that is elongated in an elongated direction. Two curved outer walls 114a are opposite to each other in the elongated direction. Two passages 142, 144 are defined in the tube connector 114. Two passages 142, 144 are spaced away from each other in the elongated direction of the tube connector 114. One of the two passages serves as an inflow passage 142 and the other of the two passages serves as an outflow passage 144.

The inflow passage 142 is in fluid communication with the first tube 104 of the circulation circuit 102 when the tube connector 114 is connected to the external connector 108. The outflow passage 144 is in fluid communication with the second tube 106 of the circulation circuit 102 when the tube connector 114 is connected to the external connector 108. The inflow tube 110 is connected between the tube connector 114 and the inlet 116 of the tank 160 such that the inflow passage 142 of the tube connector 114 is in fluid communication with the inlet 116 through the inflow tube 110. The outflow tube 112 is connected between the tube connector 114 and the outlet 118 of the tank 160 such that the outflow passage 144 of the tube connector 114 is in fluid communication with the outlet 118 through the outflow tube 112. As a result, when the tube connector 114 is connected to the external connector 108, refrigerant from the internal combustion engine flows into the tank 160 through “the first tube 104→the inflow passage 142→the inflow tube 110→the inlet 116”, and the refrigerant returns to the internal combustion engine from the tank 160 through “the outlet 118→the outflow tube 112→the outflow passage 144→and the second tube 106.

The tube connector 114 has two grooves 146 for engaging with the first and second engaging portions 136, 138. One of the two grooves 146 is formed on one of the curved outer walls 114a and the other of the two grooves 146 is formed on the other of the curved outer walls 114a. That is, the two grooves 146 are opposite to each other in the elongated direction of the tube connector 114. Each of the two grooves 146 extends across the entire length of the corresponding curved outer wall 114a along the inflow and outflow passages 142, 144.

When fixing the holder 122 to the tank 160, the holder 122 is aligned with the bracket 120 so that the two holes 134 align with the threaded hole 120a of the bracket 120. And then, the screw 124 is inserted into both the holes 134 of the first and second proximal portions 126a, 128a and the threaded hole 120a of the bracket 120. In this way, the holder 122 is loosely (tentatively) fixed to the bracket 120 by the screw 124. When the holder 122 is loosely fixed to the bracket 120, the distance between the first and second engaging portions 136, 138 is substantially the same as the distance between the two grooves 146.

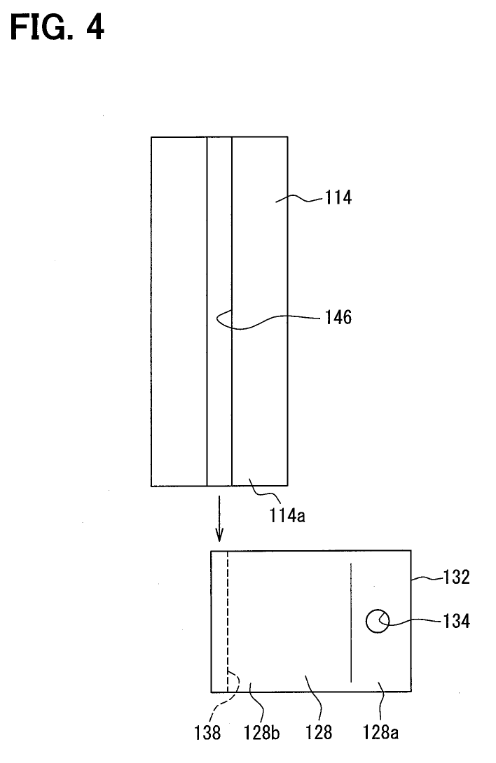

When holding the tube connector 114 in the holder 122, the tube connector 114 is inserted into the holding space S between the first and second arms 126, 128 of the holder 122, as shown in FIG. 4. In this case, the tube connector 114 is slid into the holding space S while the two grooves 146 are being guided by the first and second engaging portions 136, 138. Therefore, the tube holder 122 is readily set between the first and second arms 126, 128 by the sliding action, and thus this process can be effectively performed even in the limited space of the engine room.

In a state where the tube connector 114 is completely inserted into the holding space S of the holder 122, the screw 124 is further tightened into the threaded hole 120a of the bracket 120. As a result, the screw 124 biases the proximal portion 126a of the first arm 126 and the proximal portion 128a of the second arm 128 toward each other. Due to the biasing force, the first arm 126 and the second arm 128 flex toward each other about the connection point 132 as indicated by the chain line in FIG. 2, whereby the first and second engaging portions 136, 138 firmly engage with the tube connector 114 (the two grooves 146). In other words, the first and second engaging portions 136, 138 clamp the tube connector 114. The engaging force between the first and second engaging portions 136, 138 and the grooves 146 increases as the screw 124 tightens the first and second arms 126, 128. Therefore, the tube connector 114 can be firmly held by the holder 122 between the first and second arms 126, 128.

Moreover, the first and second arms 126, 128 are formed of resin to be elastically flexible as described before. Therefore, the first and second arms 126, 128 flexibly hold the tube connector 114, which allows the tube connector 114 to be rotatable and/or movable to some degree. More specifically, due to the flexibility of the first and second arms 126, 128, the tube connector 114 is allowed to rotate about a center point P1 between the inflow passage 142 and the outflow passage 144 to some degree. Furthermore, the first and second arms 126, 128 allow the tube connector 114 to be movable in a direction away from the tank 160 and in a direction toward the tank 160.

After holding the tube connector 114 by the holder 122, the inflow tube 110 and the outflow tube 112 are connected to the inlet 116 and the outlet 118 of the tank 160, respectively. During the connecting process of the inflow tube 110 and the outflow tube 112, a tension (or stress) may be applied to the tube connector 114 and/or the bracket 120. However, since the holder 122 flexibly holds the tube connector 114, such a tension can be released by rotation and/or movement of the tube connector 114. Thus, damage to the tube connector 114 and/or the bracket 120 due to the tension can be reduced. Furthermore, by allowing the tube connector 114 to rotate or move, the connecting process of the inflow tube 110 and the outflow tube 112 to the tank 160 can be effectively performed.

After connecting the inflow tube 110 and the outflow tube 112 to the tank 160, the external connector 108 is connected to the tube connector 114. In this case, since the holder 122 flexibly holds the tube connector 114, the external connector 108 can be easily connected to the tube connector 114 by rotating or moving the tube connector 114 to a proper orientation or position. Therefore, the connecting process of the external connector 108 to the tube connector 114 can be also effectively performed. In addition, the holder 122 releases a tension generated during the connecting process of the external connector 108, damage to the tube connector 114 and/or the bracket 120 can be reduced. By connecting the external connector 108 to the tube connector 114, the radiator 100 is in fluid communication with the internal combustion engine through the circulation circuit 102, whereby refrigerant circulates between the radiator 100 and the internal combustion engine.

As described above, the holding structure according to the present embodiment can flexibly hold the tube connector 114 through the holder 122, and therefore the connecting process of the tube connector 114 and the external connector 108 can be effectively performed even in a limited space of the engine room. Also, the flexible holding by the holder 122 can release an undesirable tension to the tube connector 114 and/or the bracket 120, which may reduce damage to the tube connector 114 and/or the bracket 120.

### Modifications to the First Embodiment

In the above-described embodiment, the holder 122 is fixed to the tank 160 of the radiator 100. Alternatively, the holder 122 may be fixed to another part of the radiator 100. For example, the holder 122 may be fixed to a reinforcing plate of the core 100a that is disposed on one side of the core 100a.

In the above-described embodiment, the radiator 100 is provided as a heat exchanger. However, other heat exchangers such as an evaporator or a condenser of an air-conditioning unit can be used, and the holder 122 may be fixed to these heat exchangers.

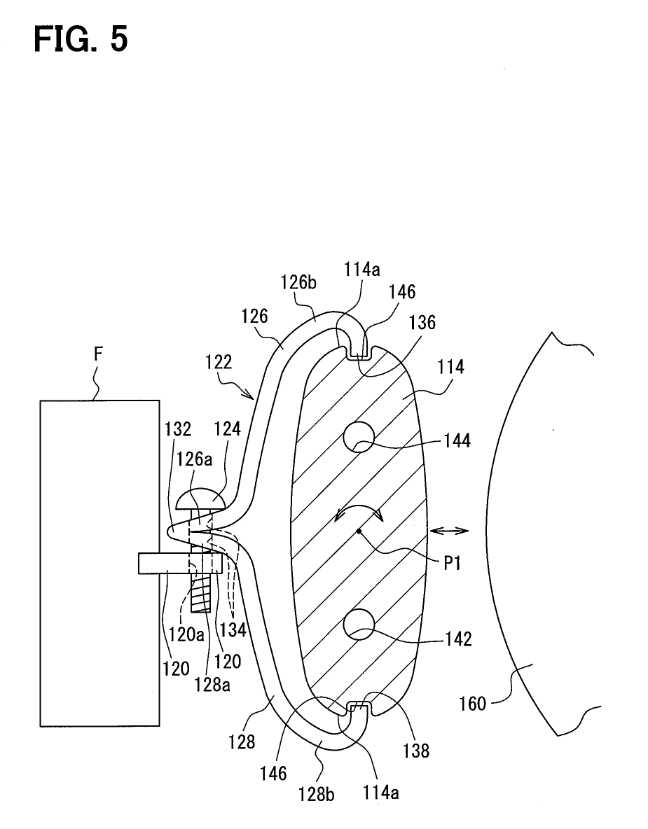

Furthermore, the holder 122 may be fixed to another in-vehicle component. For example, the holder 122 may be fixed to a frame (vehicle body) F, which defines an engine room, as shown in FIG. 5 (first modification). More specifically, the bracket 120 is fixed to the frame F, and the holder 122 may be fixed to the bracket 120 of the frame F.

In the above-described embodiment, the holder 122 is fixed by the screw 124. Alternatively, the holder 122 may be fixed by a pair of nut and bolt. In this case, the bracket 120 may have a through hole instead of the threaded hole 120a.

In the above-described embodiment, the two grooves 146 are formed in the tube connector 114 to be opposite to each other in the elongated direction (i.e., a direction along a long axis). Alternatively, the groove 146 may be formed in the tube connector 114 to be opposite to a direction that is perpendicular to the elongated direction of the tube connector 114 and that passes through the center point P1 of the tube connector 122 (i.e., a direction along a short axis). In this case, the tube connector 122 is clamped by the first and second arms 126, 128 in the direction along the short axis.

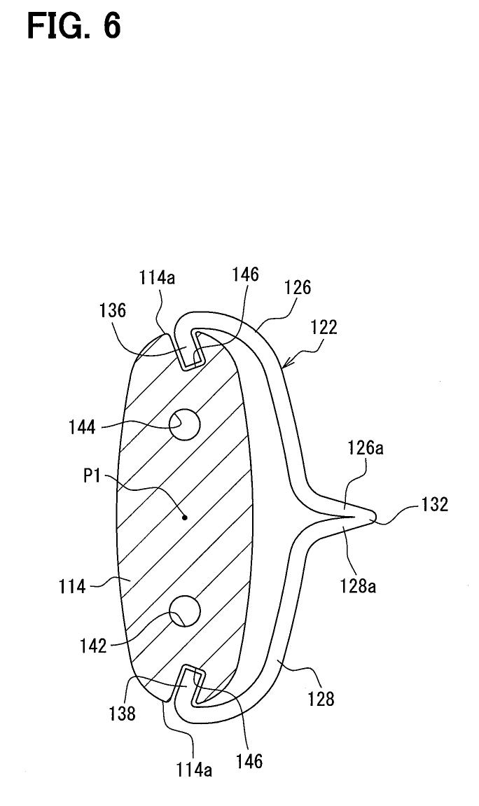

In the above-described embodiment, the first engaging portion 136 extends toward the second engaging portion 138, and the second engaging portion 138 extends toward the first engaging portion 136, as illustrated in FIG. 3. In other words, the first and second engaging portions 136 and 138 extend toward the center point P1 of the tube connector 114. However, the first engaging portion 136 and the second engaging portion 138 may extend toward the connection point 132 of the holder 122 as shown in FIG. 6 (second modification). In other words, the first engaging portion 136 may extends toward the first arm 126 and the second engaging portion 138 may extend toward the second arm 128. In the second modification, each of the two grooves 146 is recessed from the corresponding curved outer wall 114a toward the connection point 132 when the tube connector 114 is held by the holder 122.

By setting the first and second engaging portions 136, 138 as illustrated in FIG. 6, engagement between the first and second engaging portions 136, 138 and the two grooves 146 can be enhanced. Therefore, tighter and securer holding of the tube connector 114 by the holder 122 can be acquired.

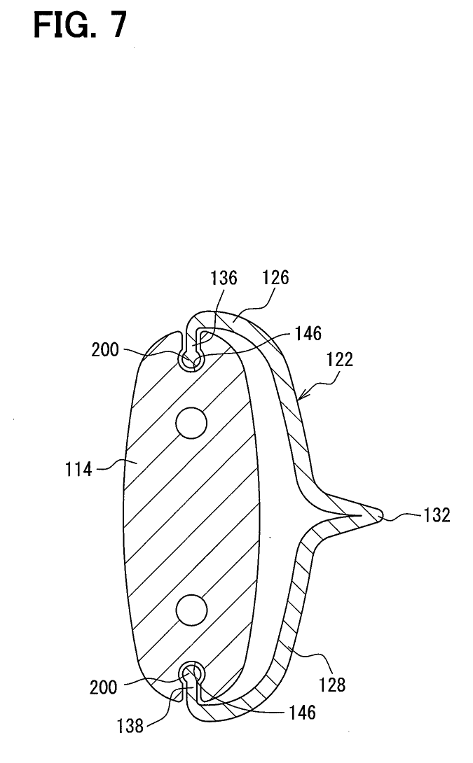

Alternatively, each of the first engaging portion 136 and the second engaging portion 138 may include a locking end 200 at a distal end thereof, as shown in FIG. 7 (third modification). The locking end 200 has a circular cross-section. In the third modification, each of the two grooves 146 is formed to have a cross-sectional shape corresponding to the corresponding engaging portion 136, 138.

By setting the first and second engaging portions 136, 138 as shown in FIG. 7, engagement between the first and second engaging portions 136, 138 and the two grooves 146 can be more enhanced. Furthermore, due to the engagement of the locking ends 200 and the two grooves 146, the tube connector 114 is allowed to be detached from the holder 122 only by sliding the tube connector 114 relative to the holder 122. In other words, it may be impossible for the tube connector 114 to be detached from the holder 122 even when a force is applied to the tube connector 114 in a direction toward or away from the holder 122.

### Second Embodiment

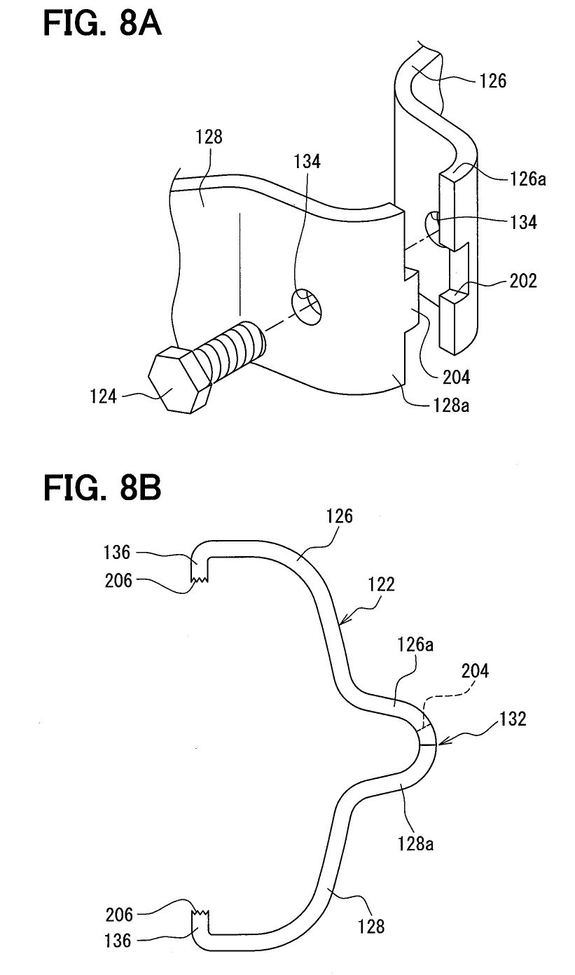

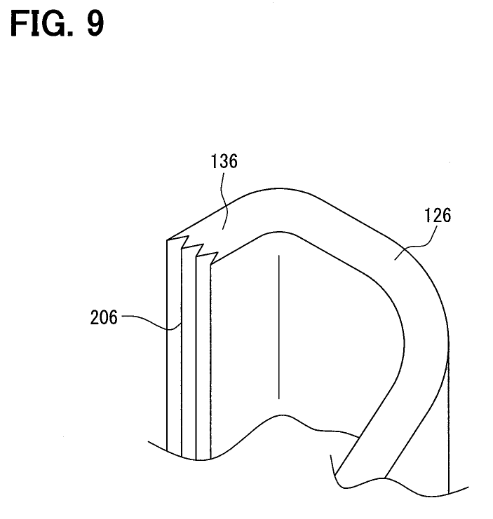

Next, a second embodiment will be described below with reference to FIGS. 8A, 8B and 9. In the first embodiment, the first and second arms 126, 128 are integrally formed, in other words, the first and second arms 126, 128 are continuously connected at the connection point 132. In the second embodiment, however, the first arm 126 and the second arm 128 are separately formed, as shown in FIG. 8A.

The first arm 126 includes a slot 202 at one end of the first arm 126 (more specifically, one end of the proximal portion 126a) opposite to the first engaging portion 136. The slot 202 is recessed from an edge of the one end of the first arm 126 toward the hole 134. In contrast, the second arm 128 includes a protrusion 204 at one end of the second arm 128 (more specifically, one end of the proximal portion 128a) opposite to the second engaging portion 138. The protrusion 204 protrudes from an edge of the one end of the second arm 128. The length of the protrusion 204 in the protruding direction is substantially the same as the depth of the slot 202 in the recessing direction.

The protrusion 204 is inserted into the slot 202 when the first and second arms 126, 128 are connected to each other. In a state where the protrusion 204 is inserted into the slot 202, the screw 124 is inserted into the two holes 134 and the threaded hole 120a (see FIG. 3) of the bracket 120. As a result, the first and second arms 126, 128 are connected to each other while the protrusion 204 is being interlocked with the slot 202. As shown in FIG. 8B, both the one ends of the first and second arms 126, 128 are in contact with each other when the first and second arms 126, 128 are connected to each other. Therefore, the two one ends of the first and second arms 126, 128 serve as the connection point 132 in the present embodiment.

Furthermore, each of the first engaging portion 136 and the second engaging portion 138 includes teeth 206 at a distal end thereof (see FIG. 9 showing the teeth 206 formed in the first engaging portion 136). By forming the teeth 206 at the distal end of each of the first and second engaging portions 136, 138, engagement between the first and second engaging portions 136, 138 and the two grooves 146 can be further enhanced. Hence, the tube connector 114 can be securely held by the holder 122 in the present embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,”“comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

What is claimed is:

1. A holder for holding a tube connector for an in-vehicle component, the holder comprising:
a first arm that has a first engaging portion;
a second arm that has a second engaging portion; and
a fastener, wherein
a proximal portion of the first arm is connected to a proximal portion of the second arm at a connection point,
the first arm and the second arm are configured to be flexible toward each other by flexing about the connection point,
the first engaging portion and the second engaging portion engage with the tube connector by clamping the tube connector therebetween, and
the fastener fixes the proximal portion of the first arm and the proximal portion of the second arm to a base while biasing the first arm and the second arm toward each other.

2. The holder according to claim 1, wherein
the fastener is one of a screw and a pair of nut and bolt,
a hole is formed in each of the first arm and the second arm, and
the fastener is inserted into the two holes to fasten the first and second arms toward each other.

3. The holder according to claim 2, wherein
an engaging force between the first and second engaging portions and the tube connector increases as the fastener fastens the first and second arms.

4. The holder according to claim 1, wherein
the first engaging portion protrudes from the first arm toward the second arm,
the second engaging portion protrudes from the second arm toward the first arm, and
the first and second engaging portions engage with two grooves formed in the tube connector.

5. The holder according to claim 1, wherein
the first engaging portion protrudes from the first arm toward the connection point,
the second engaging portion protrudes from the second arm toward the connection point, and
the first and second engaging portions engage with two grooves formed in the tube connector.

6. The holder according to claim 1, wherein
the first engaging portion protrudes from the first arm toward the second arm or the connection point,
the second engaging portion protrudes from the second arm toward the first arm or the connection point,
each of the first and second engaging portions includes a locking end at a distal end of the each of the first and second engaging portions, and
the first and second engaging portions engage with two grooves formed in the tube connector.

7. The holder according to claim 1, wherein
each of the first engaging portion and the second engaging portion includes teeth.

8. The holder according to claim 1, wherein
the first arm and the second arm are integrally formed.

9. The holder according to claim 1, wherein
the first arm and the second arm are separately formed.

10. The holder according to claim 9, wherein
the first arm includes a slot at an edge of the proximal portion thereof,
the second arm includes a protrusion at an edge of the proximal portion thereof, and
the proximal portion of the first arm is connected to the proximal portion of the second arm while the protrusion is being inserted into the slot.

11. A holding structure for an in-vehicle component, comprising:
a holder that includes a first arm having a first engaging portion and a second arm having a second engaging portion;
a tube connector that is detachably connected to an external connector; and
a fastener, wherein
a proximal portion of the first arm is connected to a proximal portion of the second arm at a connection point,
the first arm and the second arm are configured to be flexible by flexing about the connection point,
the first engaging portion and the second engaging portion engage with the tube connector by clamping the tube connector therebetween, and
the fastener fixes the proximal portion of the first arm and the proximal portion of the second arm to a base while biasing the first arm and the second arm toward each other.

12. The holding structure according to claim 11, wherein
the fastener is one of a screw and a pair of nut and bolt,
a hole is formed in each of the first arm and the second arm, and
the fastener is inserted into the two holes to fasten the first and second arms toward each other.

13. The holder according to claim 12, wherein
an engaging force between the first and second engaging portions and the tube connector increases as the fastener fastens the first and second arms.

14. The holding structure according to claim 11, wherein
two grooves are formed in the tube connector,
the first engaging portion protrudes from the first arm toward the second arm,
the second engaging portion protrudes from the second arm toward the first arm,
each of the two grooves is recessed from the tube connector toward each other, and
the first and second engaging portions engage with the two grooves.

15. The holding structure according to claim 11, wherein
two grooves are formed in the tube connector,
the first engaging portion protrudes from the first arm toward the connection point,
the second engaging portion protrudes from the second arm toward the connection point,
each of the two grooves is recessed from the tube connector toward the connection point, and
the first and second engaging portions engage with the two grooves.

16. The holding structure according to claim 11, wherein
two grooves are formed in the tube connector,
the first engaging portion protrudes from the first arm toward the second arm or the connection point,
the second engaging portion protrudes from the second arm toward the first arm or the connection point,
each of the first and second engaging portions includes a locking end at a distal end of the each of the first and second engaging portions,
one of the two grooves is recessed from the tube connector to have a cross-sectional shape corresponding to the first engaging portion,
the other of the two grooves is recessed from the tube connector to have a cross-section shape corresponding to the second engaging portion, and
the first and second engaging portions engage with the two grooves.

17. The holding structure according to claim 11, wherein
each of the first engaging portion and the second engaging portion includes teeth.

18. The holding structure according to claim 11, wherein
the first arm and the second arm are integrally formed.

19. The holding structure according to claim 11, wherein
the first arm and the second arm are separately formed.

20. The holding structure according to claim 19, wherein
the first arm includes a slot at an edge of the proximal portion thereof,
the second arm includes a protrusion at an edge of the proximal portion thereof, and
the proximal portion of the first arm is connected to the proximal portion of the second arm while the protrusion is being inserted into the slot.
